(19) United States
(12) Patent Application Publication
(10) Pub. No.: US 2017/0180520 A1
(43) Pub. Date: Jun. 22, 2017

(54) MOBILE TERMINAL AND EXTERNAL ANTENNA

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Hao WU, Beijing (CN)

(21) Appl. No.: 15/242,414

(22) Filed: Aug. 19, 2016

Related U.S. Application Data
(63) Continuation of application No. PCT/CN2016/088673, filed on Jul. 5, 2016.

(30) Foreign Application Priority Data
Dec. 16, 2015 (CN) 2015109446239

(51) Int. Cl. H04M 1/02; H04M 1/60

(52) U.S. Cl. CPC H04M 1/0202; H04M 1/6058

(57) ABSTRACT

Disclosed are a mobile terminal and an external antenna. The mobile terminal comprises: a headphone jack which comprises at least two connection terminals and is to be plugged by a connector of an external device and remains electrically connected to the said external device; an audio output module which comprises an audio connection port and is connected to a first connection terminal and a second connection terminal of the said headphone jack; and a radio frequency module comprising multiple antenna connection ports, wherein a first antenna connection port is connected to a first or second connection terminal of the said headphone jack; wherein the said first antenna connection port, via a capacitor, is coupled to the said first connection terminal or the said second connection terminal.

### CROSS REFERENCE TO RELATED APPLICATIONS

The present application is a continuation of PCT application which has an application number of PCT/CN2016/088673 and was filed on Jul. 5, 2016. The present application claims the priority of a Chinese patent application titled “mobile terminal and external antenna”, which was filed with the Chinese Patent Office on Dec. 16, 2015 and has an application number of 201510944623.9, the contents of which are incorporated by reference herein in its entirety.

### TECHNICAL FIELD

The present application relates to the technological field of transmission and reception of signals, a mobile terminal and an external antenna in particular.

### BACKGROUND

Multiple-Input and Multiple-Output (MIMO) technology was introduced in the wake of 802.11n, a Wi-Fi standard. MIMO is a kind of abstract mathematical model which describes a wireless communication system of multiple antennas. Signals are transmitted independently by each of the antennas of a transmitter, multiple antennas of a receiver, in the meantime, receive signals and restore them to original information. MIMO can substantially increase data throughput and transmission distance of a system without increasing bandwidth or total loss of transmission power, so that it attracted much attention in recent years. However, in prior art of MIMO antenna schemes, a very large space inside a cell phone is required for accommodating multiple antennas of the receiver and transmitter. Space inside a cell phone is rather small; it is for this reason, and among others, that MIMO has not been adopted by cell phones, mobile terminals and the like.

In the wake of the increasing demand by users in recent years for access to online multimedia contents, a pressing need for MIMO becomes apparent that MIMO technology needs to be applied on mobile terminals such as cell phones. Many different antennas which perform various functions for cell phones exist in prior art, including, for example, GPS antennas for realizing wireless voice call, a Wi-Fi antenna for realizing wireless connection to Internet and a Bluetooth antenna for realizing short distance transmission.

Among those antennas, GPS antennas comprise a primary antenna and at least one secondary antenna. When the primary set of antennas is in work, the secondary set must be not. In such occasion, the secondary antenna can be used, according to an antenna solution of MIMO technology, as the Wi-Fi antenna. It is often to use different secondary antennas of a cell phone as the Wi-Fi antenna time-division to implement a MIMO antenna solution so as to realize the Wi-Fi function, which is controlled by a software programme responsible for turning on and off different secondary antennas on demand. Although this way of implementation utilizes existing antennas inside a cell phone and no modification on hardware is required, more switches are needed and introduction of software switch controlling can be complex and also problematic that normal use of a cell phone, making a voice call, might be poorly affected under some complicated circumstances.

### SUMMARY

One objective of the present application is to provide a mobile terminal and an external antenna, both of which may improve the performance of wireless communication of a mobile terminal under circumstances of encountering weak signals.

According to an aspect of the present application, a mobile terminal is provided, comprising: a headphone jack which comprises at least two connection terminals and enables, when a connector of an external device is plugged into the said headphone jack, that any one of idle contacts of the said headphone jack remains electrically connected to the said external device, wherein the said external device serves as a Wi-Fi antenna in accordance with an antenna solution of MIMO; an audio output module which comprises an audio connection port and is connected to a first connection terminal and a second connection terminal of the said headphone jack; and a radio frequency module which comprises at least two antenna connection ports, wherein any one of the said at least two antenna connection ports remains electrically connected to the said idle contacts.

According to another aspect of the present application, an external antenna is provided, wherein the said external antenna is integrated into a headphone and is to be used in conjunction with the said mobile terminal according to any one of the claims 1-8, and the said external antenna, via a connector of the headphone, is plugged into the said headphone jack and is electrically connected to any one of idle contacts of the headphone jack.

A technological solution of the present application provide that the radio frequency module is electrically connected to any one of idle contacts of the headphone jack, such that the said external device remains electrically connected to any one of the idle contacts of the headphone jack when a connector of the external device is plugged into the headphone jack. Such solution further provides that the said external device serves as a Wi-Fi antenna in accordance with an antenna solution of MIMO. The performance of wireless communication of a mobile terminal becomes better, so that better user experience is achieved.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 is a structural view of a mobile terminal in accordance with an embodiment of the present invention;

FIG. 2 is an illustrative view of a logic circuit of a mobile terminal in accordance with an embodiment of the present invention; and

FIG. 3 is a structural view of a housing of a mobile terminal in accordance with an embodiment of the present invention.

### DETAILED DESCRIPTION

Exemplary embodiments of the present application will be described in more detail below with reference to the figures. Although the figures illustrate exemplary embodiments of the present application, it should be appreciated that the present application may be implemented in various forms and should not be limited by embodiments herein. On the contrary, these embodiments provide for complete understanding of the present application, and are sought to fully convey the scope of this application to those skilled in the art.

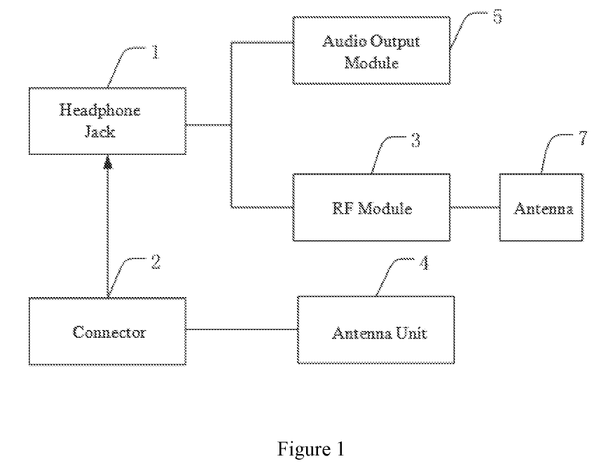

FIG. 1 is a structural view of a mobile terminal in accordance with an embodiment of the present invention. As shown in FIG. 1, the mobile terminal comprises a headphone jack 1 and a radio frequency module 3.

The headphone jack 1 comprises at least a first connection terminal 11 and a second connection terminal 12, and enables, when a connector 2 of an external device is plugged into the headphone jack 1, that any one of idle contacts of the headphone jack remains electrically connected to the external device, wherein the external device serves as a Wi-Fi antenna in accordance with an antenna solution of MIMO.

In the present embodiment, the first connection terminal 11 is a connection terminal for audio left channel, and the second connection terminal 12 is a connection terminal for audio right channel. The connector 2 is correspondingly comprises a fifth connection terminal 21 and a sixth connection terminal 22. The fifth connection terminal 21 is a connection terminal for audio left channel, and the sixth connection terminal 22 is a connection terminal for audio right channel.

In an optional embodiment, the headphone jack 1 further comprises a third connection terminal 13 and a fourth connection terminal 14, wherein the third connection terminal 13 is a ground terminal and the fourth connection terminal 14 is a connection terminal for a microphone. The connector 2 is correspondingly comprises a seventh connection terminal and an eighth connection terminal, wherein the seventh connection terminal 23 is a ground terminal and the eighth connection terminal 24 is a connection terminal for a microphone.

The radio frequency module 3 comprises at least a first antenna connection port 31 and a second antenna connection port 32, wherein the first antenna connection port 31 remains electrically connected to an idle contact.

The mobile terminal further comprises an external device, wherein the external device is an external Wi-Fi antenna comprising two connectors 2, or it is a headphone into which a Wi-Fi antenna is integrated.

The external Wi-Fi antenna comprises a connector 2 and an antenna unit 4, wherein the antenna unit 4, via the connector 2, is plugged into the headphone jack 1 and remains electrically connected to any one of idle contacts.

In an optional embodiment of the present application, the antenna unit 4 comprises a feed conductor 41 and a radiation assembly 42, one end of the feed conductor 41 is electrically connected to a connection terminal of the connector 2, and the other end of the feed conductor 41 is electrically connected to the radiation assembly 42.

In another optional embodiment of the present application, the radiation assembly is of a spiral shape, provided that the external device is an external Wi-Fi antenna.

The mobile terminal may further comprise an audio output module 5 which comprises an audio connection port and is connected to a first connection terminal 11 and a second connection terminal 12 of the headphone jack 1.

In the present embodiment, the audio output module 5 outputs audio signals via the headphone jack 1. For example, when the headphone is plugged into the headphone jack 1, the audio output module 5 may transmit audio signals, such as music, into the headphone.

In the present embodiment, when an idle contact is connected to the first antenna connection port 31, a capacitor 6 is added between them so as to achieve that audio signals are filtered from the idle contact to the first antenna connection port 31, and that only radio frequency signals can be transmitted to the radio frequency module 3. Optionally, the capacitor 6 is of the capacitance of 22 pF˜100 pF.

A technological solution of the present application provide that the radio frequency module is electrically connected to any one of idle contacts of the headphone jack, such that the external device remains electrically connected to any one of idle contacts of the headphone jack when a connector of the external device is plugged into the headphone jack. Such solution further provides that the external device serves as a Wi-Fi antenna in accordance with an antenna solution of MIMO. The performance of wireless communication of a mobile terminal becomes better, so that better user experience is achieved.

In embodiments, as shown in FIG. 1, the mobile terminal according to an embodiment of the present application further comprises an antenna 7. The antenna 7 is connected to the second antenna connection port 32 of the mentioned radio frequency module 3. The antenna 7, operating in conjunction with the radio frequency module 3, can transmit and receive radio frequency signals. Provided that an external antenna which is capable of matching the radio frequency module is plugged into the headphone jack, both the external antenna and the antenna 7 are connected to the radio frequency module. In this way, a MIMO antenna solution is realized by the external antenna and the antenna 7, and the performance of wireless communication of the mobile terminal of this embodiment becomes optimal.

The radio frequency module 3 comprises a plurality of radio frequency circuits, and the antenna 7 comprises a plurality of antennas. Provided that a Wi-Fi antenna is plugged into the headphone jack 1, the external Wi-Fi antenna operating in conjunction with the radio frequency circuits of the radio frequency module 3 transmits and receives signals. The external Wi-Fi antenna can utilize a Wi-Fi antenna which is connected to the second antenna connection port of the radio frequency module 3, and operate in conjunction with it to realize a MIMO antenna solution.

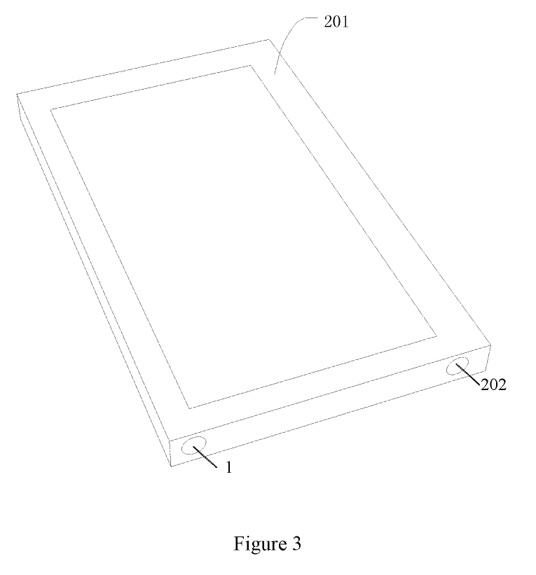

Furthermore, as shown in FIG. 3, the mobile terminal according to an embodiment of the present application further comprises a housing 201 which has a receiving space (not marked in the figure), the said headphone jack 1, the said audio output module 5 and the said radio frequency module 3 are all disposed in the said receiving space, the said housing 201 is provided with an opening by which the said headphone jack 1 is exposed, and the outer surface of the said housing 201 is provided with a receiving hole 202 for receiving an external device. In an embodiment, an external antenna which matches the radio frequency module 3 can be received in the receiving hole 202. The external antenna is only taken out from the receiving hole 202 when the need for use rises. It makes the external antenna easy for carrying and difficult to loss.

Furthermore, the receiving hole 202 may be a blind hole or through hole, which can be configured according to users' actual requirements.

In embodiments, a mobile terminal according to embodiments of the present application can be a cell phone, a laptop, a tablet or the like, which can be configured according to users' actual requirements.

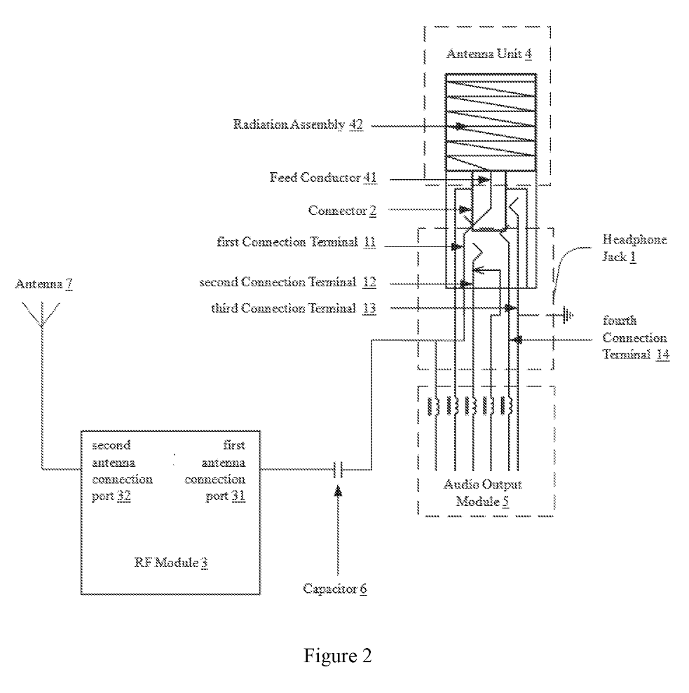

As shown in FIG. 2, embodiments of the present application further provide an external antenna, wherein the said external antenna is integrated into a headphone and is to be used in conjunction with a mobile terminal according to any of the embodiments, and the external antenna, via a connector of the headphone, is plugged into the headphone jack and is electrically connected to any one of idle contacts of the headphone jack.

In embodiments, provided that an external antenna is plugged into the headphone jack 1 of the said mobile terminal though the connector 2 of the headphone, the said external antenna is electrically connected to any one of idle contacts of the headphone jack, and transmits and receives radio frequency signals in conjunction with the radio frequency module 3.

It has to be appreciated that the mobile terminal associated with the present embodiment may employ a mobile terminal structure as described in the above embodiments. Reference may be made to corresponding contents in the above embodiments for implementation and working principles which are omitted here.

An external antenna provided by an embodiment of the present application is integrated into a headphone. When the headphone is in use, the external antenna may substantially boost the performance of wireless communication of a mobile terminal, such as a cell phone, particularly in a weak-signal environment, and speed up the Wi-Fi access to internet. Furthermore, design of external antennas can easily be standardized so as to be free from risks of impact from developments of mobile terminals such as a cell phone.

Embodiments according to the present application are described above, but these embodiments do not provide everything in detail, and none of which should limit the present disclosure. Obviously, many modifications and variations can be made according to the above depictions. In the description, these embodiments are selected and described in detail to better illustrate principles and actual application of the present application so that those skilled in the art can use the present application very well and make any modification on the basis of the present application. The present application is only limited by the claim set and all scope and equivalents thereof.

1-9. (canceled)

10. A mobile terminal, comprising:
a headphone jack which comprises at least two connection terminals and enables, when a connector of an external device is plugged into the said headphone jack, that any one of idle contacts of the said headphone jack remains electrically connected to the said external device, wherein the said external device serves as a Wi-Fi antenna in accordance with an antenna solution of Multiple-Input and Multiple-Output;
an audio output module which comprises an audio connection port and is connected to a first connection terminal and a second connection terminal of the said headphone jack; and
a radio frequency module which comprises at least two antenna connection ports, wherein any one of the said at least two antenna connection ports remains electrically connected to the said idle contacts.

11. The mobile terminal according to claim 10, wherein the said mobile terminal further comprises the said external device which is an external Wi-Fi antenna or a headphone into which a Wi-Fi antenna is integrated.

12. The mobile terminal according to claim 11, wherein the said external Wi-Fi antenna comprises a connector and an antenna unit, the said antenna unit, via the said connector, is plugged into the said headphone jack and remains electrically connected to any one of the said idle contacts.

13. The mobile terminal according to claim 12, wherein the said antenna unit comprises a feed conductor and a radiation assembly, one end of the said feed conductor is electrically connected to a connection terminal of the said connector, and the other end of the said feed conductor is electrically connected to the said radiation assembly.

14. The mobile terminal according to claim 13, wherein the said radiation assembly is of a spiral shape, provided that the said external device is an external Wi-Fi antenna.

15. The mobile terminal according to claim 13, wherein any one of the said at least two antenna connection ports is coupled to the said idle contacts via a capacitor.

16. The mobile terminal according to claim 15, wherein the said capacitor is of the capacitance of 22 pF˜100 pF.

17. The mobile terminal according to claim 10, wherein the said mobile terminal further comprises a housing which has a receiving space, the said headphone jack, the said audio output module and the said radio frequency module are all disposed in the said receiving space, the said housing is provided with an opening by which the said headphone jack is exposed, and the outer surface of the said housing is provided with a receiving hole for receiving an external device.

18. The mobile terminal according to claim 11, wherein the said mobile terminal further comprises a housing which has a receiving space, the said headphone jack, the said audio output module and the said radio frequency module are all disposed in the said receiving space, the said housing is provided with an opening by which the said headphone jack is exposed, and the outer surface of the said housing is provided with a receiving hole for receiving an external device.

19. The mobile terminal according to claim 12, wherein the said mobile terminal further comprises a housing which has a receiving space, the said headphone jack, the said audio output module and the said radio frequency module are all disposed in the said receiving space, the said housing is provided with an opening by which the said headphone jack is exposed, and the outer surface of the said housing is provided with a receiving hole for receiving an external device.

20. The mobile terminal according to claim 13, wherein the said mobile terminal further comprises a housing which has a receiving space, the said headphone jack, the said audio output module and the said radio frequency module are all disposed in the said receiving space, the said housing is provided with an opening by which the said headphone jack is exposed, and the outer surface of the said housing is provided with a receiving hole for receiving an external device.

21. The mobile terminal according to claim 14, wherein the said mobile terminal further comprises a housing which has a receiving space, the said headphone jack, the said audio output module and the said radio frequency module are all disposed in the said receiving space, the said housing is provided with an opening by which the said headphone jack is exposed, and the outer surface of the said housing is provided with a receiving hole for receiving an external device.

22. The mobile terminal according to claim 15, wherein the said mobile terminal further comprises a housing which has a receiving space, the said headphone jack, the said audio output module and the said radio frequency module are all disposed in the said receiving space, the said housing is provided with an opening by which the said headphone jack is exposed, and the outer surface of the said housing is provided with a receiving hole for receiving an external device.

23. The mobile terminal according to claim 16, wherein the said mobile terminal further comprises a housing which has a receiving space, the said headphone jack, the said audio output module and the said radio frequency module are all disposed in the said receiving space, the said housing is provided with an opening by which the said headphone jack is exposed, and the outer surface of the said housing is provided with a receiving hole for receiving an external device.

24. An external antenna, wherein the said external antenna is integrated into a headphone and is to be used in conjunction with a said mobile terminal, and the said external antenna, via a connector of the headphone of the said mobile terminal, is plugged into the said headphone jack and is electrically connected to any one of idle contacts of the headphone jack,
wherein the said mobile terminal comprises:
a headphone jack which comprises at least two connection terminals and enables, when a connector of an external device is plugged into the said headphone jack, that any idle contacts of the said headphone jack remains electrically connected to the said external device, wherein the said external device serves as a Wi-Fi antenna in accordance with an antenna solution of Multiple-Input and Multiple-Output;
an audio output module which comprises an audio connection port and is connected to a first connection terminal and a second connection terminal of the said headphone jack; and
a radio frequency module which comprises at least two antenna connection ports, wherein any one of the said at least two antenna connection ports remains electrically connected to the said idle contacts.

25. The external antenna according to claim 24, wherein the said external antenna is an external Wi-Fi antenna or a headphone into which a Wi-Fi antenna is integrated.

26. The external antenna according to claim 25, wherein the said external Wi-Fi antenna comprises a connector and an antenna unit, the said antenna unit, via the said connector, is plugged into the said headphone jack and remains electrically connected to any one of the said idle contacts.

27. The external antenna according to claim 26, wherein the said antenna unit comprises a feed conductor and a radiation assembly, one end of the said feed conductor is electrically connected to a connection terminal of the said connector, and the other end of the said feed conductor is electrically connected to the said radiation assembly.

28. The external antenna according to claim 27, wherein the said radiation assembly is of a spiral shape, provided that the said external antenna is an external Wi-Fi antenna.
